(19) United States
(12) Patent Application Publication
(10) Pub. No.: US 2021/0229311 A1
(43) Pub. Date: Jul. 29, 2021

(54) STAPLER

(71) Applicant: MAX CO., LTD., Tokyo (JP)

(72) Inventors: Hiroaki TAKAHASHI, Tokyo (JP); Yusuke KUDO, Tokyo (JP)

(73) Assignee: MAX CO., LTD., Tokyo (JP)

(21) Appl. No.: 17/155,661

(22) Filed: Jan. 22, 2021

(30) Foreign Application Priority Data
Jan. 24, 2020 (JP) 2020-010427

(51) Int. Cl. B27F 7/36; B42B 5/00; B27F 7/19

(52) U.S. Cl. CPC B27F 7/36; B27F 7/19; B42B 5/00

(57) ABSTRACT

A stapler includes a main body, a magazine having a pair of sidewalls and a tip end wall, a driver, a clincher, and a cover. The magazine is configured to be movable between a first position and a second position. A staple is capable of being taken in and out from an opening formed above the pair of sidewalls and the tip end wall when the magazine is located at the second position. The cover is attached to the main body so as to be displaceable between a third position and a fourth position. When the cover is located at the third position and the magazine is located at the second position, the cover covers the pair of sidewalls, the tip end wall and the opening of the magazine in a state of protruding from the main body.

### CROSS-REFERENCE TO RELATED APPLICATIONS

The present application claims priority from Japanese Patent Application No. 2020-010427 filed on Jan. 24, 2020, the entire content of which is incorporated herein by reference.

### TECHNICAL FIELD

The present disclosure relates to a stapler configured to stitch a sheet bundle by a staple.

### BACKGROUND ART

In the related art, a stapler configured to strike a staple into a sheet bundle to stitch the sheet bundle is used. In particular, since an electric stapler capable of automatically striking a staple into a sheet bundle does not require a force for stitching and has excellent operability, it is widely used to stitch a large amount of the sheet bundle, for example. An electric stapler disclosed in PATENT LITERATURE 1 includes a magazine configured to accommodate staples. The magazine has a structure surrounded by sidewalls and a tip end wall and opened upward. When loading staples into the magazine, the opening of the magazine is exposed from the main body (the magazine protrudes forward) and staples are loaded from the opening.

### CITATION LIST

### Patent Literature

[PATENT LITERATURE 1] JP-A-2009-241171

### SUMMARY OF INVENTION

However, for example, in a state where the magazine is exposed from the main body, when the stapler is tilted, inverted, dropped and the like, the staples are scattered from the opening of the magazine.

It is an object of the present invention to provide a stapler capable of making it difficult for a staple to pop out of a magazine and to be scattered around even when the stapler is tilted or the like in a state where the magazine is exposed from a main body.

The present disclosure relates to a stapler, including:

a main body;

a magazine having a pair of sidewalls and a tip end wall and configured to be movable between a first position at which the magazine is inserted in the main body and a second position at which the magazine protrudes from the main body, a staple being capable of being taken in and out from an opening formed above the pair of sidewalls and the tip end wall when the magazine is located at the second position;

a driver located above the magazine and configured to be movable toward the staple in the magazine when the magazine is located at the first position, the driver being configured to move toward the staple, thereby striking the staple into a sheet bundle set below the magazine;

a clincher arranged below the magazine and positioned to face the driver when the magazine is located at the first position, and configured to receive and bend leg portions of the staple penetrating the sheet bundle by a striking operation of the driver; and

a cover attached to the main body so as to be displaceable between a third position at which at least a part of the cover is positioned on a moving path of the magazine and a fourth position at which the entire cover deviates from the moving path,

wherein when the cover is located at the third position and the magazine is located at the second position, the cover covers the pair of sidewalls, the tip end wall and the opening of the magazine in a state of protruding from the main body.

According to the present disclosure, even when the magazine is located at the second position at which it protrudes from the main body, the cover is set to the third position, so that the surrounding (the pair of sidewalls, the tip end wall and the opening) of the magazine protruding from the main body is covered by the cover. For this reason, even when the stapler is tilted or the like in a state where the magazine is exposed (protrudes) from the main body, the staples in the magazine are difficult to be scattered around.

### BRIEF DESCRIPTION OF DRAWINGS

FIG. 1 is a perspective view of an electric stapler in a state where a cover in accordance with a present embodiment is closed.

FIG. 2A is a perspective view of the electric stapler in a state where the cover in accordance with the present embodiment is opened.

FIG. 2B is a perspective view of the electric stapler in a state where a magazine protrudes from a main body with the cover in accordance with the present embodiment being opened.

FIG. 3A is a perspective view of the magazine in accordance with the present embodiment.

FIG. 3B is a perspective view of the magazine in accordance with the present embodiment.

FIG. 4 is a perspective view depicting an internal configuration of the electric stapler in accordance with the present embodiment.

FIG. 5A is a side sectional view of the electric stapler in accordance with the present embodiment.

FIG. 5B is a side sectional view of the electric stapler in accordance with the present embodiment.

FIG. 6 is a side sectional view of the electric stapler in accordance with the present embodiment.

FIG. 7A depicts an operation of an unlocking mechanism in accordance with the present embodiment.

FIG. 7B depicts an operation of the unlocking mechanism in accordance with the present embodiment.

FIG. 8 is a plan view of a stitch position adjusting unit in accordance with the present embodiment.

FIG. 9 is a side view of the electric stapler in accordance with the present embodiment.

FIG. 10A depicts an operation of a cover opening/closing detector in accordance with the present embodiment.

FIG. 10B depicts an operation of the cover opening/closing detector in accordance with the present embodiment.

FIG. 11 depicts a state of the electric stapler when the magazine in accordance with the present embodiment is not locked.

FIG. 12 is a block diagram depicting a functional configuration of the electric stapler in accordance with the present embodiment.

FIG. 13 is a flowchart depicting an example of operations when a stitch processing operation of the electric stapler in accordance with the present embodiment is executed.

FIG. 14 is a perspective view of an electric stapler in a state where a cover in accordance with a modified embodiment is opened.

FIG. 15 is a side sectional view of the electric stapler in accordance with the modified embodiment.

### DESCRIPTION OF EMBODIMENTS

Hereinbelow, preferred embodiments of the present disclosure will be described in detail with reference to the accompanying drawings.

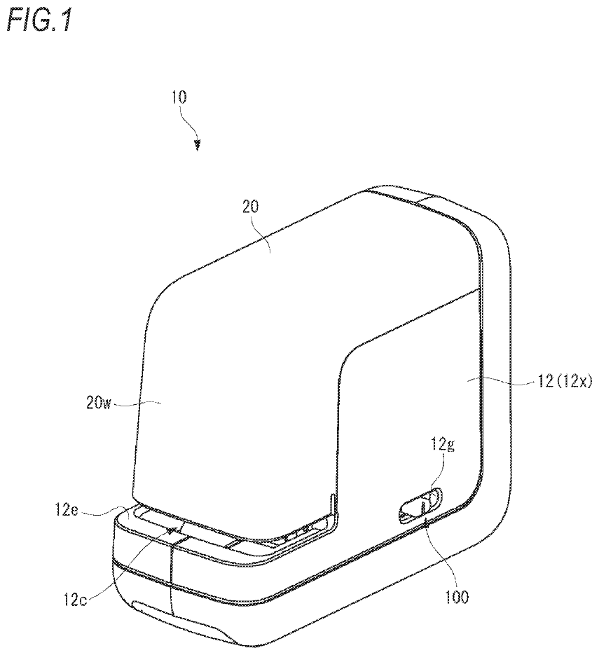

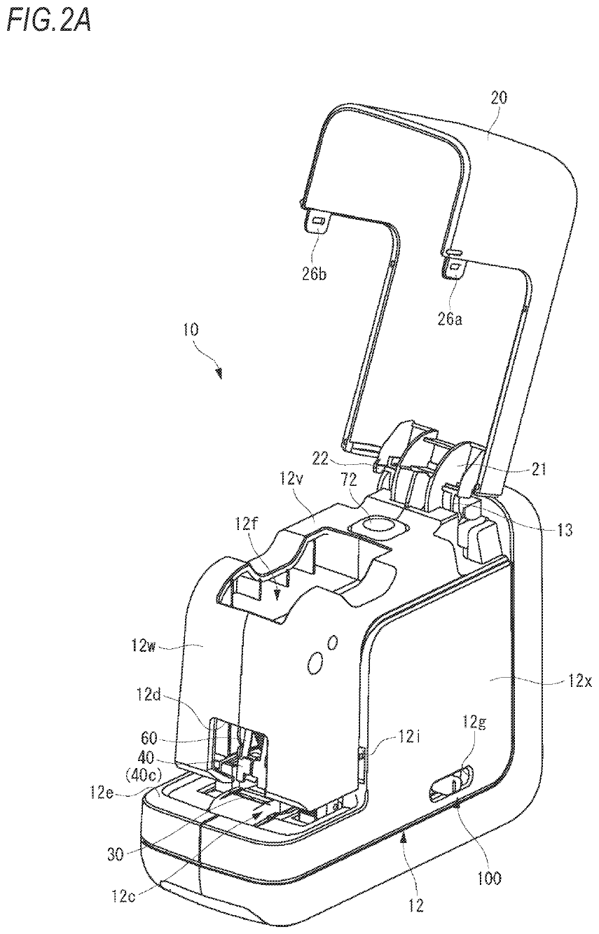

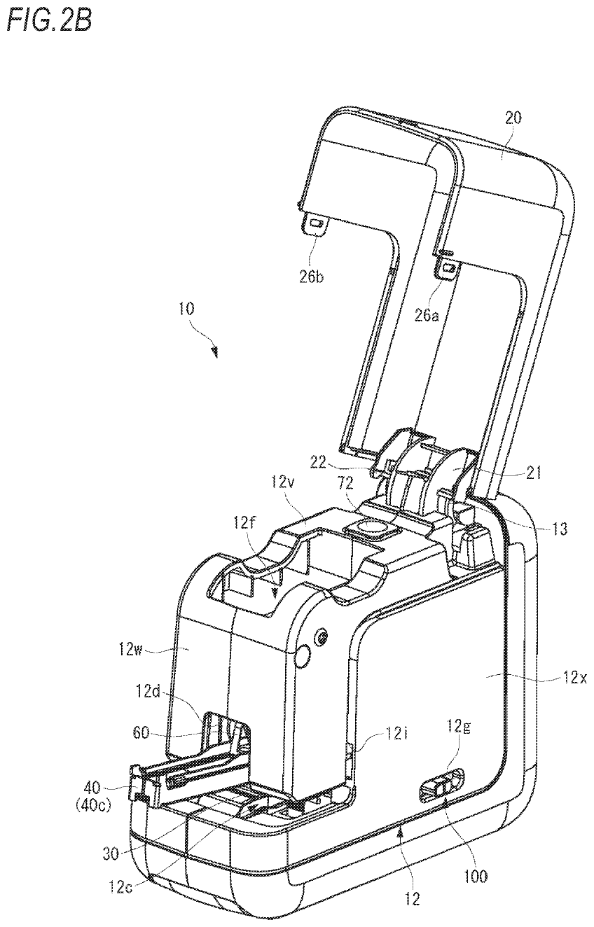

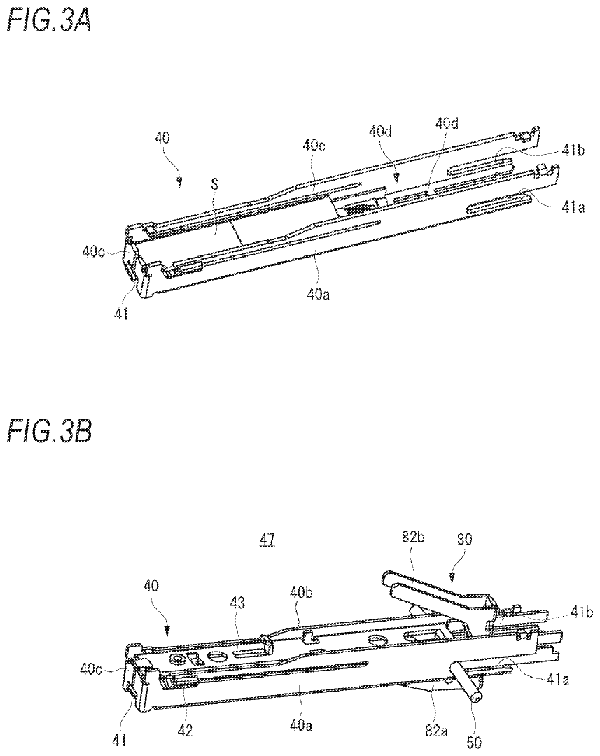

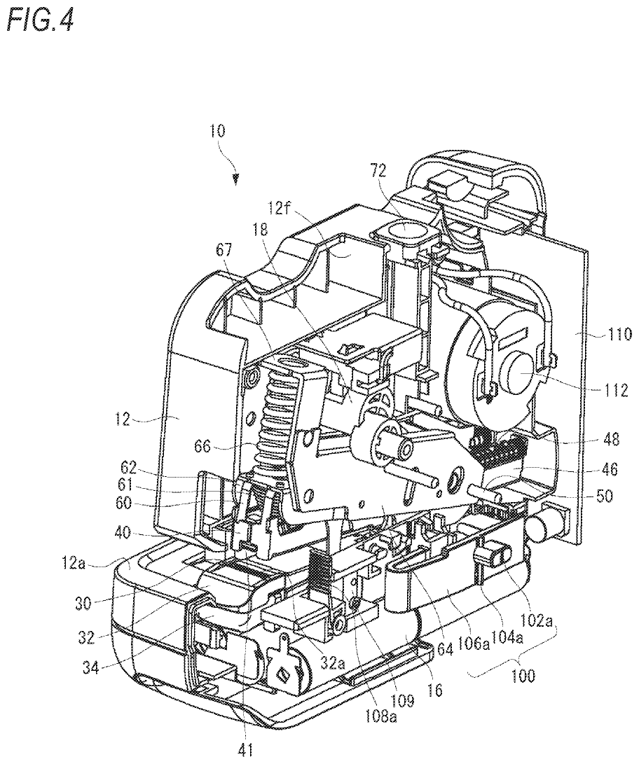

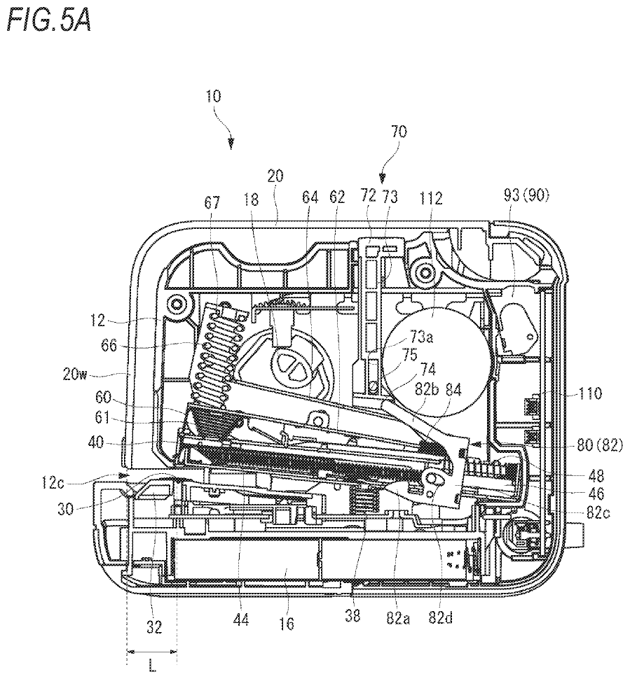

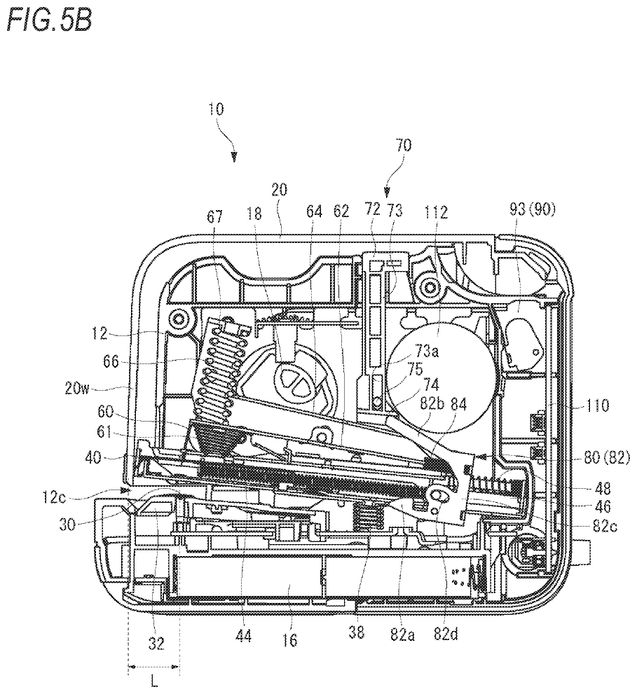

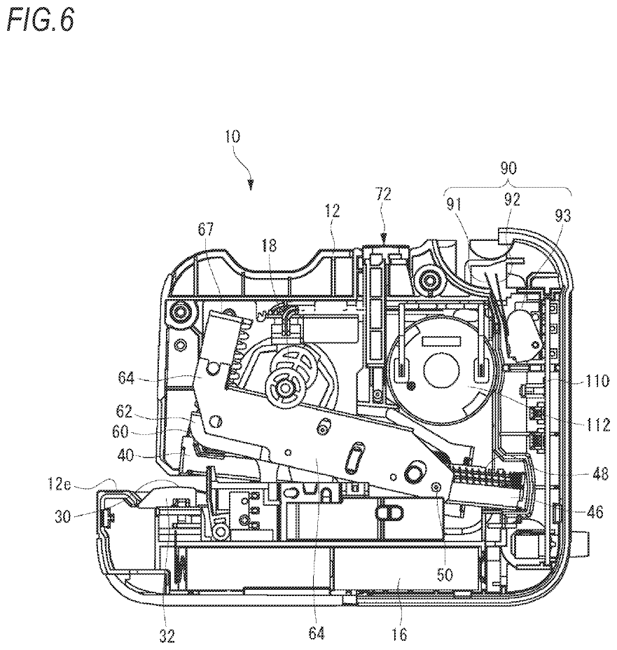

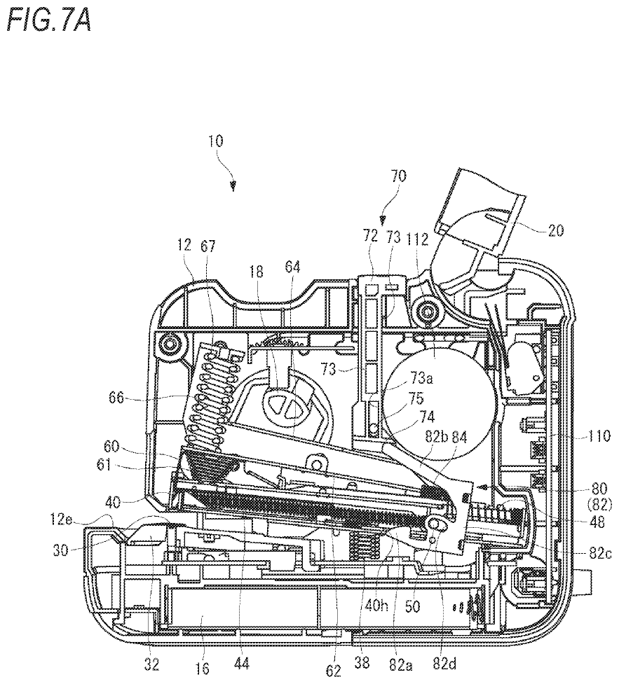

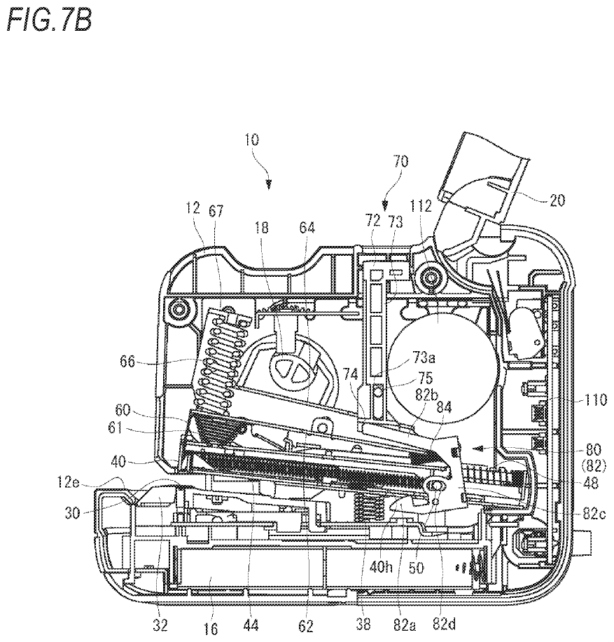

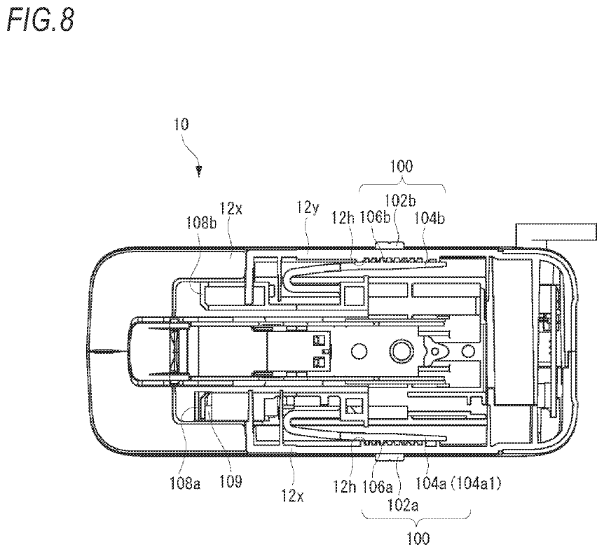

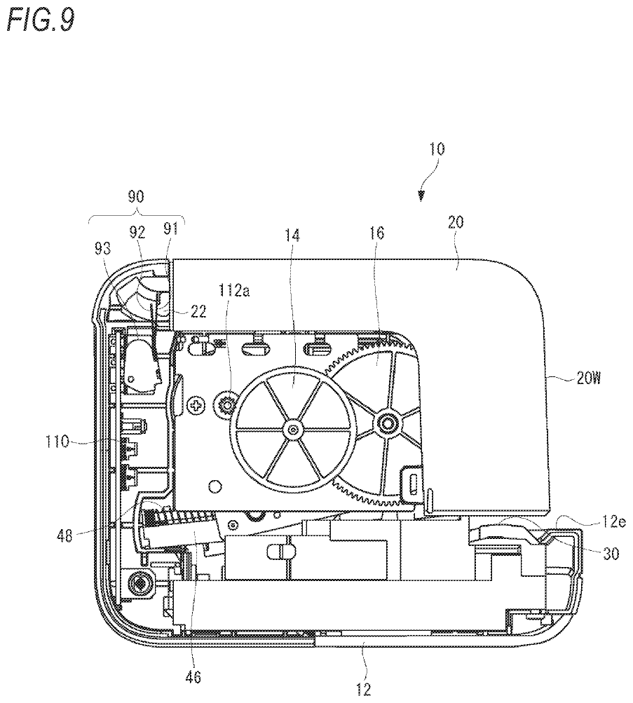

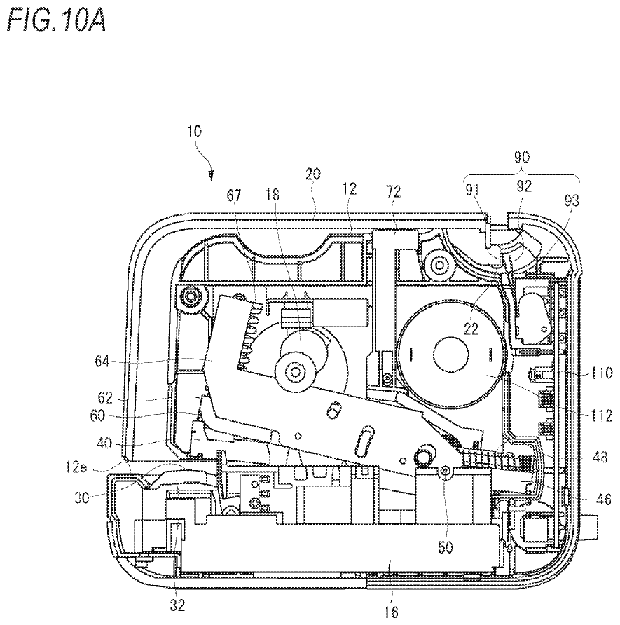

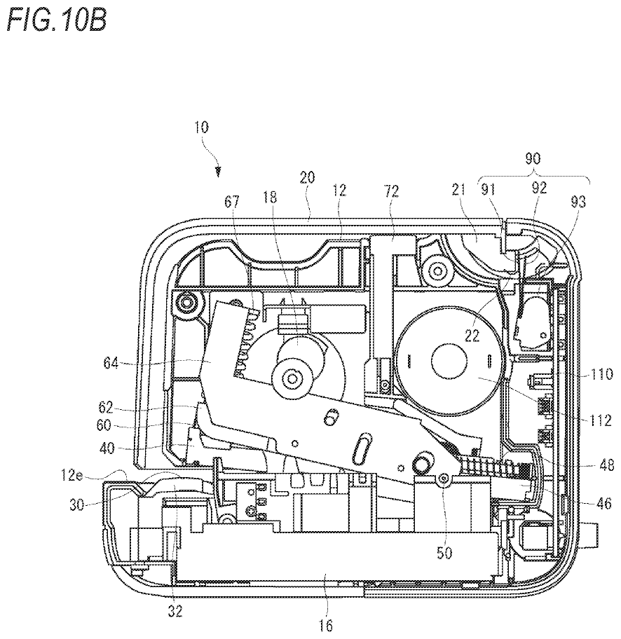

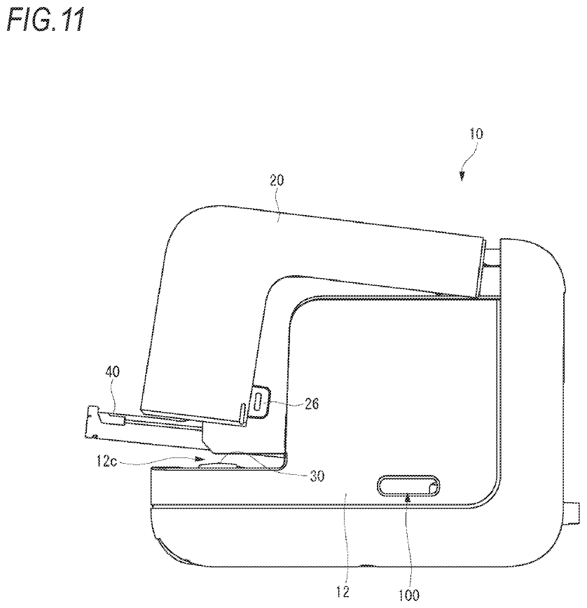

FIG. 1 is a perspective view of an electric stapler 10 in a state where a cover in accordance with the present embodiment is closed, FIGS. 2A and 2B are perspective views of the electric stapler 10 in a state where the cover 20 is opened, FIGS. 3A and 3B are perspective views of a magazine 40 in accordance with the present embodiment, FIG. 4 is a perspective view depicting an internal configuration of the electric stapler 10, FIGS. 5A, 5B and 6 are side sectional view of the electric stapler 10. FIGS. 7A and 7B depict operations of an unlocking mechanism 70 in accordance with the present embodiment. FIG. 8 is a plan view of a stitch position adjusting part 100 in accordance with the present embodiment. FIG. 9 is a side view of a drive unit of the electric stapler 10 in accordance with the present embodiment. FIGS. 10A and 10B depict operations of a cover opening/closing detector 90 in accordance with the present embodiment. FIG. 11 depicts a state of the electric stapler when the magazine in accordance with the present embodiment is not locked.

Note that, in an electric stapler 10 in accordance with the present embodiment shown in FIG. 1 and the like, a side on which an insertion opening 12c for inserting a sheet bundle to a stitch position is provided is referred to as a front side of the electric stapler 10, and an opposite side thereto is referred to as a rear side of the electric stapler 10. A side on which a release button 72 for pulling out a magazine 40 from a main body 12 is provided is referred to as an upper side of the electric stapler 10, and an opposite side thereto is referred to as a lower side of the electric stapler 10.

### Configuration Example of Electric Stapler 10

As shown in FIG. 1 or FIG. 2A, the electric stapler 10 in accordance with the present embodiment includes a main body 12, and a cover 20 configured to cover a part of the main body 12.

As shown in FIG. 2A, the main body 12 is a cuboid-shaped box body having a front surface 12w, an upper surface 12V, a left side surface 12x, a right side surface (not shown) and the like. An insertion opening 12c for inserting a sheet bundle to a stitch position is provided below the front surface 12w of the main body 12. A lower side (lower surface) of the insertion opening 12c further protrudes forward than the insertion opening 12c so that the sheet bundle can be easily placed (set) thereon when inserting the sheet bundle into the insertion opening 12c.

The front surface 12w of the main body 12 is formed with a pullout opening 12d above the insertion opening 12c, and a magazine 40 for accommodating staples and a driver 60 for striking out the staples accommodated in the magazine 40 are provided inside of the pullout opening. A clincher 30 configured to receive and bend leg portions of the staple penetrating the sheet bundle set in the insertion opening 12c by a striking operation of the driver 60 is provided below the magazine 40 with the insertion opening 12c being positioned therebetween.

The upper surface 12V of the main body 12 is provided with a release button 72 for pulling out the magazine 40 from the main body 12 (pullout opening 12d). As shown in FIG. 2B, when the release button 72 is pushed, the magazine 40 protrudes from the main body 12. A stitch position adjusting part 100 for adjusting a stitch position in a front and rear direction is provided below the left side surface 12x of the main body 12. In the present embodiment, the stitch position adjusting part 100 is provided at each of a left side part and a right side part of the main body 12. The upper surface 12V of the main body 12 is provided with an accommodation part 12f in which a coupled staple of a plurality of staples coupled to each other, a package in which a plurality of coupled staples is accommodated, and the like can be accommodated.

Note that, herein, as shown in FIG. 2A, a position of the magazine 40 in a state where the magazine is set in the main body 12 and staples S in the magazine 40 can be struck by the driver 60 may be described as a first position, and as shown in FIG. 2B, a position of the magazine 40 in a state where the magazine 40 protrudes from the main body 12 (pullout opening 12d) may be described as a second position. Note that, the second position may be any position at which the magazine 40 protrudes from the main body 12, and an amount of protrusion does not matter. That is, the second position includes not only a position at which a majority of the magazine 40 protrudes, as shown in FIG. 2B, but also a position at which the magazine slightly protrudes.

The cover 20 is rotatably attached to the main body 12 via a hinge part 21 provided at a rear end portion and an attachment part 13 provided at the rear of the upper surface 12V of the main body 12. As shown in FIG. 2A, when the cover 20 is rotated upward and thus opened, the front surface 12w and the upper surface 12V of the main body 12 are exposed, and when the cover 20 is closed, the front surface 12w and the upper surface 12V of the main body 12 are covered by the cover 20 (refer to FIG. 1). Note that, after the cover 20 is closed, when the cover 20 is slid rearward, convex portions 26a and 26b provided to the cover 20 fit with mounting holes 12i (only one mounting hole is shown) provided to the main body 12, so that the cover 20 is locked to the main body 12.

As shown in FIG. 3A, the magazine 40 is an elongated box body having a bottom wall 40d, a pair of sidewalls 40a and 40b (a left sidewall 40a and a right sidewall 40b) erected from the bottom wall 40d and facing each other, and a tip end wall 40c connecting tip end edges of the left sidewall 40a and the right sidewall 40b, and opened upward (having an opening 40e). A lower portion of the tip end of the magazine 40 is formed with a striking-out opening 41 spanning a boundary edge between the tip end wall 40c and the bottom wall 40d. When struck by the driver 60, the staple S in the magazine 40 is struck out downward toward the sheet bundle via the striking-out opening 41.

The left sidewall 40a and the right sidewall 40b of the magazine 40 are formed with a pair of first groove 41a and second groove 41b notched from a base end portion toward the tip end-side. The first groove 41a and the second groove 41b are engaged with a main pin 50 provided to the main body 12, and the first groove 41a and the second groove 41b move relative to the main pin 50 in the front and rear direction, so that the magazine 40 moves in the front and rear direction. As shown in FIG. 3B, when the main pin 50 is positioned at tip end portions of the first groove 41a and the second groove 41b, the magazine 40 is located at the first position. The magazine 40 also rotates in the upper and lower direction about the main pin 50 as a support point. In the magazine 40, a pusher 42 for pressing the staple toward the striking-out opening 41 is provided. When the magazine 40 is located at the first position, the opening 40e is covered by a magazine cover 43.

As shown in FIGS. 4, 5A and 5B, and the like, a magazine holder 46 configured to support the magazine 40 so that the magazine 40 can be inserted and pulled out is provided outside of the magazine 40. The main pin 50 is inserted at a substantially central portion of the magazine holder 46 in the front and rear direction, so that the magazine holder 46 rotates about the main pin 50 as a support point, together with the magazine 40. In the magazine 40, a compression spring 44 for urging the pusher 42 toward the striking-out opening 41 is provided.

A compression spring 48 for urging forward the magazine 40 is arranged between a rear end portion of the magazine holder 46 and a rear end portion of the magazine 40, so that when the magazine 40 is unlocked, the magazine 40 is pushed forward and thus protrudes forward from the main body 12.

As shown in FIGS. 4, 5A and 5B, and the like, the driver 60 is located above the magazine 40 and can move toward the staple in the magazine 40 when the magazine 40 is located at the first position. When the driver 60 moves toward the staple, the staple is struck into the sheet bundle set below the magazine 40. The driver 60 is configured by a flat plate attached to a tip end portion of a driver arm 62 extending in the front and rear direction of the magazine 40 and extending downward from the tip end portion of the driver arm 62. The driver 60 is attached to the driver arm 62 so as to intersect with, for example, to be orthogonal to a plane of the sheet bundle when striking the staple into the sheet bundle. When striking the staple into the sheet bundle, a front end face of the driver 60 presses a crown portion of the staple to strike out the staple. The driver 60 is configured to be movable toward and away from the magazine 40 in conjunction with rotation of the driver arm 62.

As shown in FIGS. 4 and 6, a handle arm 64 formed of a flat plate having a U-shaped section is provided above the driver arm 62. The handle arm 64 is provided overlapping the driver arm 62 with a predetermined interval from the driver arm 62. A rear end portion of the handle arm 64 is rotatably supported by the main pin 50.

A compression spring 66 for absorbing a change in moving amount of the driver arm 62 due to a thickness of the sheet bundle is provided on a front end-side and above the handle arm 64.

A coil spring 61 is arranged between a front end portion of the driver arm 62 (driver 60) and a front end portion of the magazine 40. The coil spring 61 is set to have stronger elastic force than a coil spring 38, and urges upward the driver 60 and the driver arm 62 with respect to the magazine 40 so that the driver 60 can stand by above the striking-out opening 41 of the magazine 40.

As shown in FIGS. 4, 5A and 5B, and the like, when the magazine 40 is located at the first position, the clincher 30 is arranged below the magazine 40 and positioned to face the driver 60, and receives and bends the leg portions of the staple penetrating the sheet bundle by the striking operation of the driver 60. An upper surface of the clincher 30 is formed with a groove portion that functions as a guide for bending inward both the leg portions of the staple along a backside of the sheet bundle. The clincher 30 is accommodated in an opening 32a formed at a front end portion of a clincher guide 32 so that it can swing in the upper and lower direction.

A clincher arm 34 is provided below the magazine 40 and outside of the clincher guide 32. A rear end portion of the clincher arm 34 is rotatably supported by the main pin 50.

A coil spring 38 is arranged between the rear end portion of the clincher arm 34 and the rear end portion of the magazine 40. The coil spring 38 urges upward the magazine 40 with respect to the clincher arm 34. Thereby, a predetermined space for inserting the sheet bundle, i.e., the insertion opening 12c is formed between the clincher 30 and the striking-out opening 41 of the magazine 40.

The cover 20 is configured to be displaceable between a third position (refer to FIGS. 1, 5A and 5B, and the like) at which at least a part of the cover 20 is positioned on a moving path of the magazine 40 and a fourth position (refer to FIGS. 2A and 2B, and the like) at which the entire cover 20 deviates from the moving path of the magazine 40. As used herein, the “moving path of the magazine 40” means a locus through which the magazine 40 passes when moving between the first position at which the magazine 40 is inserted into the main body 12 and the second position at which the magazine protrudes from the main body 12, and the description “at least a part of the cover 20 is positioned on the moving path of the magazine 40” means a state in which at least a part of the cover 20 blocks the moving path of the magazine 40 and the magazine 40 cannot thus further move forward. Therefore, the “third position” may be any position at which the cover 20 blocks the moving path of the magazine 40, and the cover 20 is not necessarily required to be completely closed at the third position. Similarly, the “fourth position” may be any position at which the cover 20 does not exist on the moving path of the magazine 40. In other words, at the fourth position, the magazine 40 is in a state in which it can move up to the maximum protrusion position without being blocked by the cover 20, and the cover 20 is not necessarily required to be completely opened, as shown in FIG. 2A and FIG. 2B.

As shown in FIGS. 1 and 2A, and the like, in the present embodiment, the cover 20 has a substantially L-shaped side shape and a substantially U-shaped section. With such shape, when the cover 20 is closed, more specifically, when the cover 20 is located at the third position, the upper surface 12V and the front surface 12w and parts of the right side surface and the left side surface 12x of the main body 12 can be covered with a bent tip end part of the cover 20. The upper surface 12V and the front surface 12w and parts of the right side surface and the left side surface 12x of the main body 12 are covered, so that even if the magazine 40 protrudes from the main body, it is possible to cover the left sidewall 40a, the right sidewall 40b, the tip end wall 40c and the opening 40e of the magazine 40, i.e., substantially the entire magazine 40 by the cover 20. For this reason, even when the magazine 40 protrudes from the main body 12 in a state where the cover 20 is located at the third position, the staples in the magazine 40 are not scattered around. Note that, the hinge part 21 for opening and closing the cover 20 is provided with a pressing part 22 for turning on a cover opening/closing detector 90, which will be described later. According to the present embodiment, since the cover 20 is simply opened and closed about the hinge part 21 and the like as a support point, it is possible to move the cover 20 between the third position and the fourth position with a simple configuration. That is, it is possible to simplify the structure and to reduce the number of components. In addition, since the cover 20 is simply opened and closed in the upper and lower direction, it is possible to implement movement between the third position and the fourth position with a simple operation.

In the present embodiment, as shown in FIGS. 5A and 5B, when the cover 20 is located at the third position, a distance L between a front wall 20w of the cover 20 facing the tip end wall 40c of the magazine 40 and a stitch position in a moving direction of the magazine 40 at which the sheet bundle is stitched with a staple by the driver 60 and the clincher 30 is set to 13 mm.

In an electric stapler of the related art, a distance between an end face of an insertion opening and a stitch part is set extremely short (for example, 5 mm) so as to rapidly stitch a sheet bundle and to make a size of an entire device (particularly, a size in the front and rear direction) compact. However, when the distance is short, even if an object (which is not limited to a sheet) is inserted by a small amount through the insertion opening, the object is detected, so that stitch processing is performed. As a result, for example, when an object other than a sheet is erroneously inserted, it is detected, so that the stitch processing may be unintentionally performed. Therefore, in order to solve the problem, the distance from the end face of the insertion opening to the stitch part is preferably set long. However, as described above, the stitch processing cannot be quickly performed and the size of the entire device becomes large. Therefore, the inventors have devoted themselves to examining a distance of solving the tradeoff, i.e., suppressing an object from being unintentionally stitched, not impairing promptness of the stitch processing and not increasing the size of the device as much as possible. As a result, the inventors found out that the distance is preferably 10 mm to 20 mm when stitching about 20 to 50 sheets, 13 mm to 20 mm when stitching 30 to 50 sheets, and 15 mm to 20 mm when stitching 40 to 50 sheets.

In the present embodiment, the cover 20 is provided to cover the insertion opening 12c, so that the distance L from the front wall 20w of the cover 20 to the stitch part is set to 13 mm.

In this way, the distance L is set within the range from 10 mm to 20 mm according to the number of sheets for which the stitch processing can be performed, so that it is possible to suppress the object from being unintentionally stitched, not to impair the promptness and not to increase the size of the device as much as possible. In the present embodiment, when the cover 20 is located at the third position, the cover 20 is located in front of an entry of the insertion opening 12c. Therefore, it is possible to lengthen the distance L from the entry of the insertion opening 12c to the stitch position by a thickness of the cover 20.

As shown in FIGS. 5A and 5B, the electric stapler 10 includes a lock mechanism 80 for locking the magazine 40 at the first position in the main body 12, and an unlocking mechanism 70 for releasing a locked state of the magazine 40 by the lock mechanism 80.

As shown in FIG. 5A and the like, the lock mechanism 80 has a lock part 82 provided at the rear of the magazine 40 and configured to lock the magazine 40 at the first position, and a compression spring 84 for urging the lock part 82 to a position at which the magazine 40 is locked.

The lock part 82 has a substantially U-like side shape opened forward and has a hook 82a provided at a lower end portion, an engaged portion 82b provided at an upper end portion and a connection portion 82c for connecting the hook 82a and the engaged portion 82b. A long hole 82d extending substantially in the front and rear direction is formed on a lower part-side of the connection portion 82c. The main pin 50 is inserted in the long hole 82d, and the lock part 82 can rotate about the main pin 50 as a support point. The compression spring 84 is arranged above the long hole 82d of the connection portion 82c, and expands and contracts to urge rearward the connection portion 82c according to a state of the lock part 82 that is tilted by pressing on the release button 72.

The hook 82a is configured to fit in an opening 40h formed in a bottom surface of the magazine 40, and fits in the opening 40h to lock the magazine 40 at the first position and to keep a state in which the magazine 40 is accommodated in the main body 12. The engaged portion 82b extends from the connection portion 82c toward an engaging part 74, and a tip end portion thereof is in contact with a lower surface of the engaging part 74.

As shown in FIG. 7A, when the magazine 40 is located at the first position at which it is accommodated in the main body 12 in a state before the release button 72 is pressed by a user, an upper part of the connection portion 82c is urged rearward by the compression spring 84, so that the hook 82a is urged toward the magazine 40 about the main pin 50 as a support point. Thereby, the state where the hook 82a is fitted in the opening 40h of the magazine 40 is maintained, and the magazine 40 is locked at the first position by the hook 82a. The first position is a position at which the magazine 40 is locked by the lock part 82.

In contrast, when pulling out the magazine 40 from the main body 12, as shown in FIG. 7B, the user moves the cover 20 from the third position to the fourth position, and then presses the release button 72. In conjunction with this, the engaging part 74 integrally formed with the release button 72 is moved downward, so that the engaged portion 82b of the lock part 82 is pressed downward. The lock part 82 is rotated in a counterclockwise direction about the main pin 50 as a support point, so that the compression spring 84 is compressed. The hook 82a is moved downward away from the magazine 40 and is disengaged from the opening 40h of the magazine 40, so that the locked state of the magazine 40 by the lock mechanism 80 is released. Thereby, the magazine 40 is pushed forward of the main body 12 by the urging force of the compression spring 48. The magazine 40 is moved from the first position to the second position, so that the tip end-side of the magazine 40 protrudes from the front wall of the main body 12. The second position is a position at which the magazine 40 is not locked by the lock part 82.

As shown in FIGS. 2 and 5A, and the like, the unlocking mechanism 70 is a mechanism for pulling out the magazine 40 forward of the main body 12 when loading staples in the magazine 40, for example. The unlocking mechanism 70 includes the release button 72, a connection part 73 attached to a lower surface of the release button 72 and extending in the upper and lower direction, and the engaging part 74 attached to a lower end portion of the connection part 73 and to be engaged with the engaged portion 82b of the lock mechanism 80. Note that, in the present embodiment, the release button 72, the connection part 73 and the engaging part 74 are integrally formed. However, the present disclosure is not limited thereto.

The release button 72 is arranged on the upper surface of the main body 12 at the rear of the accommodation part 12f, and is located inside of the cover 20 when the cover 20 is located at the third position. Thereby, only when the cover 20 is located at the fourth position at which it is opened, a user's pressing operation on the release button 72 can be received. A lower side of the connection part 73 is formed with a long hole 73a extending in the upper and lower direction, a shaft 75 is inserted in the long hole 73a, and the connection part 73 is configured to be movable along the long hole 73a about the shaft 75 as a support point. Thereby, when the release button 72 is pressed by the user, the release button 72 is pushed down with respect to the upper surface of the main body 12.

As shown in FIGS. 4 and 5A, and the like, a motor 112 is provided above the magazine 40 at the rear in the main body 12. The motor 112 is a drive source of the electric stapler 10, and is configured by a DC brushless motor, for example. A variety of wires of the motor 112 are connected to a controller 110. The controller 110 includes a substrate on which an electronic component (which will be described later) is mounted and a control circuit is formed, for example, and is arranged at the rear of the motor 112 in the main body 12.

As shown in FIG. 9 and the like, a gear 14 is connected to a rotary shaft 112a of the motor 112, a gear 16 is connected to the gear 14, and a cam 18 is connected to a rotary shaft of the gear 16. Thereby, a rotational force of the motor 112 is transmitted to the cam 18 via the gear 14 and the gear 16. The cam 18 is arranged substantially above the handle arm 64, and is contacted to an upper surface of the handle arm 64 according to a rotating angle of the cam 18, thereby pressing down the driver arm 62 and the handle arm 64, etc. toward the clincher 30.

As shown in FIGS. 4 and 5A and the like, the electric stapler 10 includes a cover opening/closing detector 90 configured to detect a state where the cover 20 is located at the fourth position with respect to the main body 12 and a state where the cover 20 is located at the third position with respect to the main body 12. The cover opening/closing detector 90 corresponds to an example of the detector, is mounted on the substrate of the controller 110, and is arranged at a position facing the pressing part 22 when the cover 20 is located at the third position (refer to FIG. 10A).

The cover opening/closing detector 90 includes a first switch pressing part 91, a second switch pressing part 92, and a switch 93. The first switch pressing part 91 is formed by a plate spring, for example, and is arranged overlapped in front of the second switch pressing part 92. The second switch pressing part 92 is configured by a spring, for example, and is arranged in front of the switch 93. As shown in FIG. 10A, when the cover 20 is rotated from the fourth position to the third position and is slid further rearward to the lock position, the first switch pressing part 91 and the second switch pressing part 92 are pressed by the pressing part 22 of the cover 20, as shown in FIG. 10B. Thereby, the second switch pressing part 92 is tilted rearward and the switch 93 is turned on. Note that, the present disclosure is not limited thereto. For example, the switch 93 may also be turned on and off by opening and closing the cover 20.

The switch 93 is configured by a micro switch, for example. When the switch 92 is turned on by the second switch pressing part 92, it generates a closing signal, which indicates that the cover 20 is closed, and outputs the same to the controller 110. When the closing signal is supplied from the switch 93, the controller 110 switches the electric stapler 10 from a stitch-inoperable state to a stitch-operable state. In this way, in the present embodiment, the cover opening/closing detector 90 functions as a so-called interlock, and the stitch processing of the electric stapler 10 cannot be executed unless the cover 20 moves to the third position, which is the lock position.

As shown in FIG. 11, in a state where the magazine 40 is not locked by the lock part 82, the magazine 40 is urged forward by the compression spring 48 (refer to FIG. 5A), so that the magazine 40 is moved from the first position to the second position and protrudes forward from the main body 12. In this state, when it is intended to move the cover 20 from the fourth position to the third position, the lower end portion of the cover 20 collides and interferes with the upper surface of the magazine 40 protruding from the main body 12, so that the cover 20 cannot be moved to the third position. Thereby, since the cover 20 cannot be moved to the lock position, the cover opening/closing detector 90 functioning as an interlock cannot be turned on. As a result, since the electric stapler 10 cannot be switched to an operation start state, it is possible to prevent a situation where the stapler operates in a state where the magazine 40 is not normally locked and a staple is not ejected from the magazine and is thus deformed to cause a jamming.

The stitch position adjusting parts 100 have pressing portions 102a and 102b provided on the right and left sides of the main body 12, support portions 104a and 104b for elastically supporting the pressing portions 102a and 102b, and two sheet guides 108a and 108b for abutting against a tip end portion of the sheet bundle. Note that, in the below, since the stitch position adjusting parts 100 have the common configuration on the right and left sides and operate in conjunction with each other on the right and left sides, the configuration on the left side may be described for convenience.

The pressing part 102a is configured by a button for the user to press and move in the front and rear direction when adjusting a stitch position on the sheet bundle, and is provided to protrude from an opening 12g (refer to FIG. 1) formed in the left side surface 12x of the main body 12.

The support portion 104a is configured by a plate spring formed by bending a flat plate into a substantial U-shape, and an outer end portion 104a1 is urged toward and abutted against the left side surface 12x of the main body 12. The pressing part 102a is attached on an outer surface-side of the support portion 104a, so that the support portion 104a is elastically deformed according to a pressing operation on the pressing portion 102a. The outer surface-side of the support portion 104a is also formed with a convex portion 106a that can be fitted with a plurality of concave portions 12h formed on an inner side of the left side surface 12x of the main body 12.

The sheet guide 108a is provided in front of the support portion 104a, and is abutted against the tip end portion of the sheet bundle inserted from the insertion opening 12c. At the rear of the sheet guide 108a, a sheet bundle detector 109 configured to start a stitch processing operation in conjunction with an operation of the sheet guide 108a is provided. When the tip end portion of the sheet bundle abuts against the sheet guide 108a, the sheet bundle detector 109 is turned on to generate an on-signal, which is then output to the controller 110.

When the user adjusts the stitch position, the user presses the left and right pressing portions 102a and 102b to disengage the convex portions 106a and 106b from the concave portions 12h. In this state, the user moves the sheet guides 108a and 108b to a targeted stitch position, and then releases the pressing on the pressing portions 102a and 102b. Thereby, the convex portions 106a and 106b are again fitted with the concave portions 12h, so that the sheet guides 108a and 108b can be set to the targeted stitch position.

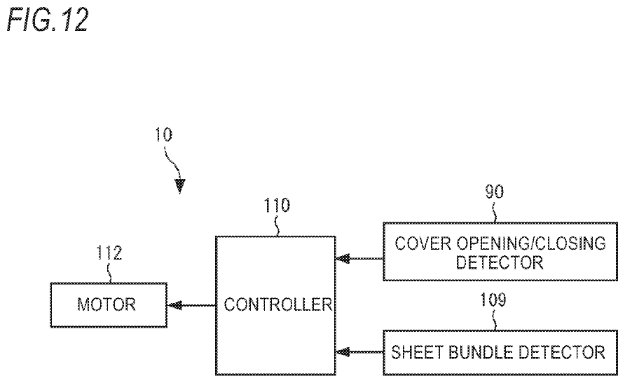

FIG. 12 is a block diagram depicting a functional configuration of the electric stapler 10. As shown in FIG. 12, the electric stapler 10 includes the controller 110. The controller 110 includes a CPU (Central Processing Unit) having arithmetic and control functions and a memory such as a ROM (Read only memory) and a RAM (Random access memory), for example. The controller 110 is connected to the cover opening/closing detector 90, the sheet bundle detector 109 and the motor 112. The controller 110 is configured to control rotation of the motor 112, based on a closing signal supplied from the cover opening/closing detector 90 and a setting completion signal supplied from the sheet bundle detector 109.

### Operation Example of Electric Stapler 10

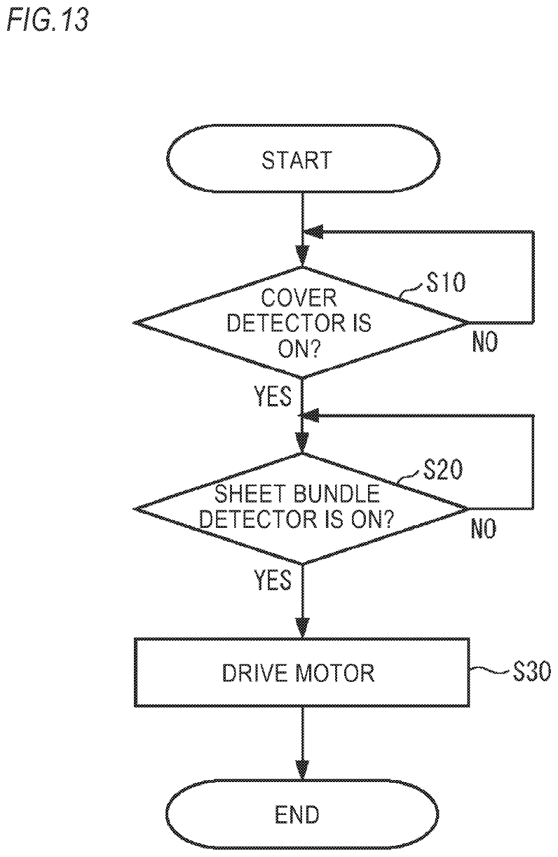

Subsequently, an example of a stitch operation of the electric stapler 10 in accordance with the present embodiment is described. FIG. 13 is a flowchart depicting an example of operations when the stitch processing operation of the electric stapler 10 is executed. Note that, it is assumed that a power supply of the electric stapler 10 is on and the cover 20 is located at the fourth position with respect to the main body 12, i.e., the cover 20 is in an opened state.

When the cover 20 is operated from the fourth position to the third position by the user, the cover 20 is closed with respect to the main body 12. In this state, when the cover 20 is slid to the lock position, the convex portions 26a and 26b of the cover 20 are fitted in the mounting holes 12i of the main body 12. Thereby, the cover 20 is locked with respect to the main body 12.

In the present embodiment, when the cover 20 is moved to the lock position, the first switch pressing part 91 and the second switch pressing part 92 configuring the cover opening/closing detector 90 are pressed rearward by the pressing part 22 of the cover 20. Thereby, the switch 93 is turned on and a closing signal is supplied to the controller 110. When the controller 110 is supplied with the closing signal from the switch 93 and determines that the cover opening/closing detector 90 is turned on, the controller 110 switches the electric stapler 10 from a stitch-inoperable state to a stitch-operable state (step S10 in FIG. 13).

Subsequently, when a sheet bundle is inserted into the insertion opening 12c of the main body 12 by the user, a tip end face of the sheet bundle is abutted against the sheet guides 108a and 108b. Thereby, the sheet guides 108a and 108b are moved rearward, so that the sheet bundle detector 109 is turned on and a setting completion signal indicating setting completion of the sheet bundle at the stitch position is supplied to the controller 110.

When the controller 110 receives the setting completion signal, the controller 110 determines that the sheet bundle detector 109 is turned on, and controls a drive circuit and the like so as to generate a drive signal for driving the motor 112 (step S20 in FIG. 13). The motor 112 rotates under control of the controller 110 (step S30 in FIG. 13). The rotation of the motor 112 causes the cam 18 to rotate in the counterclockwise direction via the gear 14 and the gear 16. In the present embodiment, while the cam 18 rotates one revolution, the stitch processing operation is executed one time.

Specifically, while the cam 18 rotates in the counterclockwise direction, the handle arm 64 is pressed downward by the cam 18, so that the driver arm 62 and the driver 60 are moved downward. In conjunction with this, the magazine 40 is moved downward and the staple loaded in the magazine 40 is struck out by the driver 60 and is then struck into the sheet bundle placed on a placing base 12e. The staple struck in the sheet bundle penetrates the sheet bundle in a thickness direction, and the leg portions of the staple are bent inwardly along a backside of the sheet bundle by the clincher 30. Thereby, the sheet bundle is stitched by the staple.

When the cam 18 further rotates, the pressing force on the handle arm 64 gradually decreases according to a rotating angle of the cam 18. When the cam 18 is spaced from the upper surface of the handle arm 64, the handle arm 64, the driver arm 62 and the driver 60 are moved upward and return to the original initial positions.

The cover 20 is not limited to the present embodiment. For example, the cover 20 may rotate in the right and left direction (for example, a rotation support point of the cover 20 may be provided at a left end or a right end and the cover 20 may be displaced between the third position and the fourth position by rotating the cover 20 in the right and left direction), not in the upper and lower direction. In addition, the cover 20 may be slid in the right and left direction or the like for opening and closing, not the rotation. Also, the cover 20 may be configured to be detachably attached to the main body 12. The cover 20 may also be provided in plural, not one. The attachment position, more specifically, the rotation support point of the cover 20 may be provided at a front end portion of the upper surface 12V of the main body 12, for example, not the rear end portion of the upper surface 12V of the main body 12. In this way, the cover 20 can be provided at a place where the cover 20 can be configured to be displaceable between the third position at which it is positioned on the moving path of the magazine 40 and the fourth position at which it deviates from the moving path. That is, when the cover 20 can be configured to be displaceable between the third position on the moving path of the magazine 40 and the fourth position deviating from the moving path of the magazine 40, the attachment structure, the attachment position and the like of the cover 20 are not limited to the specific shape and structure.

As described above, according to the present embodiment, since the cover 20 is arranged at the third position on the moving direction in which the magazine 40 protrudes forward from the main body 12, the pair of left sidewall 40a and right sidewall 40b and the tip end wall 40c of the magazine 40 moving to the second position can be covered by the cover 20. Thereby, even when the locked state of the magazine 40 is suddenly released due to tilting, falling and the like of the electric stapler 10, the magazine 40 can be prevented from protruding forward from the main body 12. As a result, the staples loaded in the magazine 40 can be prevented from being scattered around.

In the present embodiment, the release button 72 is arranged inside of the cover 20. Therefore, the release button 72 cannot be operated unless the cover 20 is opened at the fourth position. Thereby, since the release button 72 is not exposed, unlike the related art, it is possible to prevent the release button 72 from being erroneously operated while carrying the electric stapler 10, for example. As a result, it is possible to prevent the magazine 40 from unintentionally protruding forward of the main body 12.

According to the present embodiment, when the magazine 40 is not locked at the first position, the magazine 40 protrudes forward of the main body 12. For this reason, for example, even if the user forgets to accommodate the magazine 40 into the main body 12 after loading the staples in the magazine 40, when closing the cover 20, the cover 20 collides with the protruding magazine 40 and cannot move to the third position. Thereby, when performing the stitch processing, the user can visually recognize and easily check whether the magazine 40 is locked to the main body 12. Also, since it is not necessary to provide a sensor for detecting whether the magazine 40 is locked to the main body 12, it is possible to reduce the cost of the electric stapler 10.

According to the present embodiment, since the magazine 40 can be positioned by abutting the magazine 40 against the main pin 50, the magazine 40 is positioned by sizes of the first groove 41a and the second groove 41b, and the like. Thereby, unlike the electric stapler of the related art where it is necessary to control the size of the magazine 40 by two components, for example, according to the present embodiment, it is sufficient to control only the sizes of the components of the magazine 40, so that it is possible to increase a size tolerance for one component. As a result, it is possible to suppress the management cost and the cost of the electric stapler 10 itself.

### Modified Embodiments of Electric Stapler 10

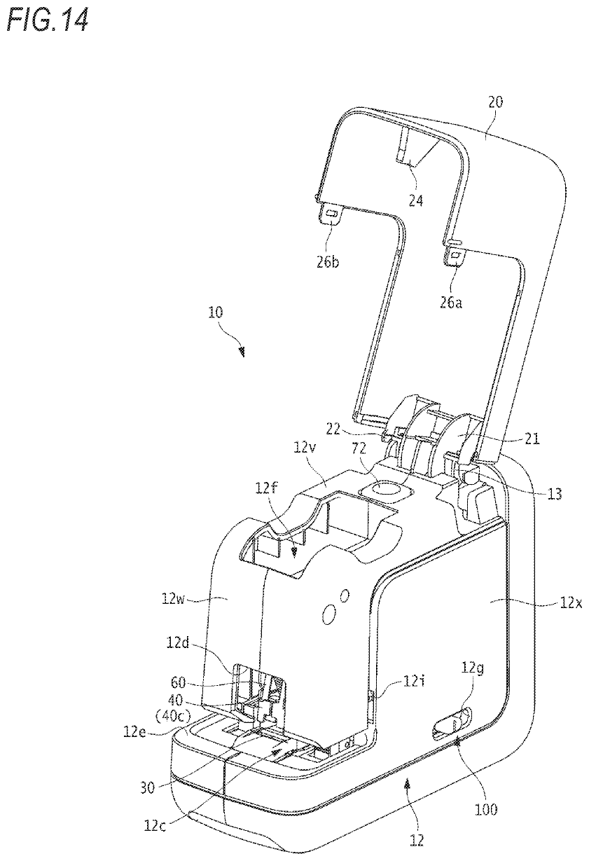

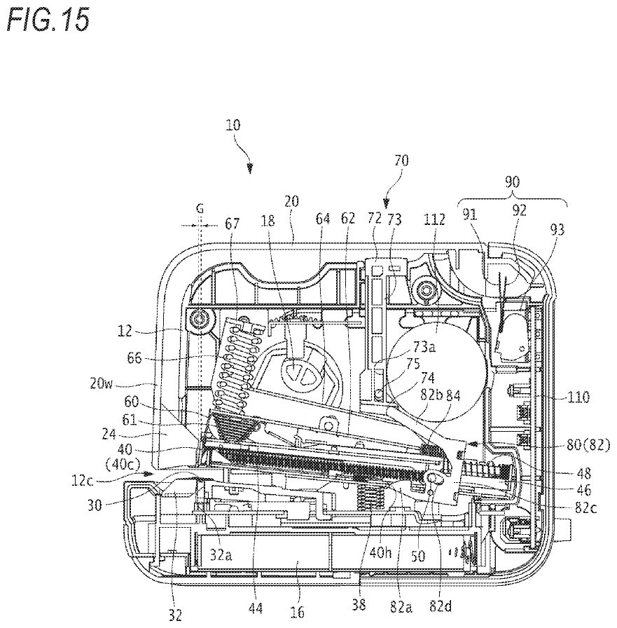

FIG. 14 is a perspective view of the electric stapler 10 in a state where the cover 20 in accordance with a modified embodiment is opened, and FIG. 15 is a side sectional view of the electric stapler 10 in accordance with the modified embodiment. Note that, the constitutional elements having substantially the same functional configurations as the electric stapler 10 of the embodiment are denoted with the same reference signs, and the overlapping descriptions thereof are omitted.

As shown in FIGS. 14 and 15, a magazine restraint part 24 that can abut against the tip end wall 40c of the magazine 40 configured to move between the first position and the second position may be provided on an inner surface of the front wall 20w of the cover 20. The magazine restraint part 24 corresponds to an example of the restraint part, and is configured by a convex part protruding from the inner surface of the front wall 20w of the cover 20 toward the magazine 40. A surface facing the magazine 40 is provided at a slight gap from the tip end wall 40c of the magazine 40 located at the first position. The gap G is set within a range in which even when an unlocking force is applied to the magazine 40, the magazine restraint part 24 can abut against the tip end wall 40c of the magazine 40 moving forward to restrain an amount of forward protrusion of the magazine 40 and cause the magazine 40 to standby at the first position that is the lock position. Note that, a dimension of protrusion of the magazine restraint part 24 may also be defined so that the facing surface of the magazine restraint part 24 is to abut against the tip end wall 40c of the magazine 40 located at the first position. Also, in the case where the cover 20 is provided with the magazine restraint part 24, when the cover 20 is closed, the magazine 40 does not protrude forward of the main body 12 even though the release button 72 is pushed. In this configuration, the release button 72 may be arranged outside of the cover 20, not inside of the cover 20.

According to the present modified embodiment, the magazine restraint part 24 is provided on the inner surface of the front wall 20w of the cover 20. Therefore, when the cover 20 is arranged at the third position, it is possible to cause the magazine 40 to standby at the first position without causing the magazine 40 to protrude forward of the main body 12. That is, since it is possible to restrain the amount of forward protrusion of the magazine 40 from the main body 12 by the magazine restraint part 24, it is possible to make a state in which the hook 82a of the lock mechanism 80 can always fit in the opening 40h of the magazine 40. Thereby, even when the hook 82a of the lock mechanism 80 is instantaneously disengaged from the opening 40h, the magazine 40 can be again locked by the hook 82a. In addition, since poor stitch, deformation of the staple and damage of the driver 60 caused due to deviation of the standby position of the magazine 40 can be prevented, the reliability of the stitch processing can be improved.

Although the preferred embodiments of the present disclosure have been described in detail with reference to the accompanying drawings, the technical scope of the present disclosure is not limited thereto. A variety of changes or modifications that can be conceived within the scope of the technical spirit defined in the claims by one skilled in the art of the present disclosure are included in the technical scope of the present disclosure.

In the embodiments, the electric stapler 10 configured to automatically strike the staple into the sheet bundle has been described. However, the present disclosure is not limited thereto. For example, the configuration of the cover 20 and the like described in the embodiment and modified embodiment can also be applied to a stapler configured to manually strike a staple into a sheet bundle and having a configuration where a magazine protrudes forward from a main body.

What is claimed is:

1. A stapler comprising:
a main body;
a magazine having a pair of sidewalls and a tip end wall and configured to be movable between a first position at which the magazine is inserted in the main body and a second position at which the magazine protrudes from the main body, a staple being capable of being taken in and out from an opening formed above the pair of sidewalls and the tip end wall when the magazine is located at the second position;
a driver located above the magazine and configured to be movable toward the staple in the magazine when the magazine is located at the first position, the driver being configured to move toward the staple, thereby striking the staple into a sheet bundle set below the magazine;
a clincher arranged below the magazine and positioned to face the driver when the magazine is located at the first position, and configured to receive and bend leg portions of the staple penetrating the sheet bundle by a striking operation of the driver; and
a cover attached to the main body so as to be displaceable between a third position at which at least a part of the cover is positioned on a moving path of the magazine and a fourth position at which the entire cover deviates from the moving path,
wherein when the cover is located at the third position and the magazine is located at the second position, the cover covers the pair of sidewalls, the tip end wall and the opening of the magazine in a state of protruding from the main body.

2. The stapler according to claim 1, wherein the cover is rotatably attached to the main body, and is configured to be displaced between the third position and the fourth position through rotation.

3. The stapler according to claim 2, wherein when the cover is located at the fourth position, the part of the cover is positioned higher when the cover is located at the third position.

4. The stapler according to claims 1, wherein when the cover is located at the third position, a distance between an end face of the cover facing the tip end wall of the magazine and a stitch position in a moving direction of the magazine at which the sheet bundle is stitched with the staple by the driver and the clincher is equal to or larger than 10 mm and equal to or smaller than 20 mm.

5. The stapler according to claim 1, further comprising:
a detector configured to detect that the cover is located at the third position; and
a controller that enables the striking operation of the driver when it is detected by the detector that the cover is located at the third position.

6. The stapler according to claim 1, further comprising:
a lock part configured to lock the magazine at the first position; and
an unlocking part configured to release the locked state,
wherein the unlocking part is located inside of the cover when the cover is located at the third position.

7. The stapler according to claim 6, further comprising an elastic member for urging the magazine toward the second position,
wherein the magazine is configured to move to the second position by urging of the elastic member in a state where the cover is located at the fourth position and is not locked to the main body by the lock part.

8. The stapler according to claim 1, wherein the cover has a restraint part that restrains the magazine to the first position when the cover is located at the third position.

9. The stapler according to claim 8, wherein the restraint part is provided on an inner wall of the cover.

10. The stapler according to claim 9, wherein the restraint part is provided at a position facing the tip end wall of the magazine.
